(19) United States
(12) Patent Application Publication
(10) Pub. No.: US 2019/0317734 A1
(43) Pub. Date: Oct. 17, 2019

(54) METHODS, SYSTEMS, ARTICLES OF MANUFACTURE AND APPARATUS TO IMPROVE CODE CHARACTERISTICS

(71) Applicant: Intel Corporation, Santa Clara, CA (US)

(72) Inventors: Li Chen, Hillsboro, OR (US); Justin Gottschlich, Santa Clara, CA (US); Alexander Heinecke, San Jose, CA (US); Zheng Zhang, Portland, OR (US); Shengtian Zhou, Palo Alto, CA (US)

(21) Appl. No.: 16/456,984

(22) Filed: Jun. 28, 2019

(51) Int. Cl. G06F 8/33; G06N 3/08

(52) U.S. Cl. CPC G06F 8/33; G06N 3/08

(57) ABSTRACT

Methods, apparatus, systems and articles of manufacture are disclosed to improve code characteristics. An example apparatus includes a weight manager to apply a first weight value to a first objective function, a state identifier to identify a first state corresponding to candidate code, and an action identifier to identify candidate actions corresponding to the identified first state. The example apparatus also includes a reward calculator to determine reward values corresponding to respective ones of (a) the identified first state, (b) one of the candidate actions and (c) the first weight value, and a quality function definer to determine a relative highest state and action pair reward value based on respective ones of the reward values

### FIELD OF THE DISCLOSURE

This disclosure relates generally to code development activity, and, more particularly, to methods, systems, articles of manufacture and apparatus to improve code characteristics.

### BACKGROUND

In recent years, code developers (e.g., human programmers, programmers, software development personnel, etc.) have been inundated with many different programming languages, algorithms, data types and/or programming objectives. Such code developers also have a vast quantity of selections for integrated development environments (IDEs), such as Microsoft Visual Studio®, Eclipse®, etc. The various IDEs provide the code developers with development environments that suit personal preferences and include different types of code development features, such as spell checking and code-formatting.

### BRIEF DESCRIPTION OF THE DRAWINGS

FIG. 1 is a schematic illustration of an example code updating system to improve code characteristics.

FIG. 2 is a schematic illustration of an example code updater of FIG. 1 to improve code characteristics.

FIGS. 3-6 depict flowcharts representative of example computer-readable instructions that may be executed to implement the example code updater of FIGS. 1 and 2 to improve code characteristics in accordance with teachings of this disclosure.

FIG. 7 is a block diagram of an example processing platform structured to execute the instructions of FIGS. 3-6 to implement the example code updater of FIGS. 1 and 2 to improve code characteristics in accordance with teachings of this disclosure.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Despite a vast assortment of integrated development environments (IDEs) and corresponding features associated with such IDEs, code developers are chartered with a responsibility to become experts in many different aspects of programming tasks. Such diverse and numerous programming tasks include, but are not limited to, writing code in different computer languages, writing code for different types of computer systems, writing code to facilitate diverse memory management algorithms, and writing code in view of security considerations, some of which involve high-profile risks in the event of one or more security breaches (e.g., retailer customer data theft and/or involuntary disclosure).

While a code developer must write code that targets a particular task, the resulting code to accomplish that task has any number of associated objective functions. As used herein, objective functions are parameters or characteristics of the code that correspond to preferences of a particular code developer. Example objective functions include, but are not limited to, code performance characteristics, code correctness characteristics, code originality characteristics, code vulnerability characteristics, security characteristics, and programming style characteristics.

In some examples, industry standard code is available to the code developer. As used herein, industry standard code represents code that accomplishes a particular task and has been tested by one or more code development communities and deemed exceptional at the particular task. In some examples, the industry standard code accomplishes the particular task, but exhibits one or more objective functions that are not aligned with one or more preferences of the code developer. In other words, while some industry standard code is very good at a particular task, it may not be particularly good at performing that task in a manner that maximizes an associated objective function (e.g., the code may not efficiently utilize platform resources, but is very secure, or the code might be very efficient when using platform resources, but not very secure). For instance, the code developer may have a particularly strong preference or need to create code (e.g., a code segment) that is secure. In some examples, a code corpus (e.g., one or more local and/or remote storage locations (e.g., cloud storage) having candidate code segments capable of accomplishing the particular task, including portions of industry standard code) includes two or more code segments capable of accomplishing the particular task. In the event one of those candidate code segments has an associated objective function that is particularly well suited for robust security performance, then that code segment may be a leading preference of the code developer. However, code developers have more than one objective function to be satisfied for a particular code development task.

When more than one objective function is to be satisfied for a particular code development task, examples disclosed herein learn and/or otherwise adapt preferences of the code developer to generate optimized code in a manner that satisfies the objective functions based on weighted vectors and reward considerations (e.g., reward functions). As used herein, a reward represents feedback or a result that can be measured in response to a particular state/action pair/combination. For example, while a code developer may place a relative weight (preference) on an objective function associated with code performance, and place another relative weight on an objective function associated with code security, such selected objective functions may conflict with each other to varying degrees.

For instance, consider candidate code that satisfies the code performance objective function to a relatively high degree, but operates in a manner without concern for code security. Upon the addition of code aspects associated with the code security objective function, such security algorithms and/or code techniques typically add computational resource burdens to accomplish the improved security behaviors of the code. As such, some objective functions exhibit a reduced effect at the expense of other objective functions. Stated differently, certain objective functions cannot simply be maximized without consideration for the effect on other objective functions (e.g., there is tension between the effort of maximizing all objective functions).

Examples disclosed herein develop optimized code in a manner that considers the two or more objective functions and/or preferences of the code developer. In some examples, methods, apparatus, systems and/or articles of manufacture disclosed herein apply reinforcement learning techniques in a particular manner to dynamically adjust relative weights associated with two or more objective functions, in which the relative weights are learned from code developer observation(s) and/or feedback. In some examples, the code developer identifies and/or otherwise associates relative weights to particular objective functions so that code optimization efforts identify an optimum code sample that best satisfies the objective functions (e.g., a wholistic and/or aggregate consideration of objective functions). In some examples, the reinforcement learning techniques are applied in connection with reward policy algorithms (e.g., quality (Q) value techniques) and estimated by neural networks (e.g., a convolutional neural network(s) (CNNs)).

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a reinforcement model (reinforcement learning) is used. Using a reinforcement model enables arbitrary behaviors to play-out scenarios such that an agent can identify how to act/perform in an effort to maximize a reward (or minimize a punishment). As used herein, an agent is a representation of the influence of making a change, such as a code function that, when executed, causes activity and a change in state. In some examples disclosed herein, an agent is referred-to as a sub-agent. In general, machine learning models/architectures that are suitable to use in the example approaches disclosed herein will be reinforcement learning techniques. However, other types of machine learning models/techniques could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, in some examples hyperparameters are used as part of the training process to control how the learning is performed (e.g., a learning rate, a number of layers to be used in the machine learning model, a discount factor, etc.). Hyperparameters are defined to be training parameters that are determined, for example, prior to initiating the training process.

Different types of training may be performed based on the type of ML/AI model/technique and/or the expected output. For example, supervised training uses inputs and corresponding expected (e.g., labeled) outputs to select parameters (e.g., by iterating over combinations of select parameters) for the ML/AI model that reduce model error. Generally speaking, supervised learning/training is particularly useful when predicting values based on labeled data. As used herein, labelling refers to an expected output of the machine learning model (e.g., a classification, an expected output value, etc.) Alternatively, unsupervised training/learning (e.g., used in deep learning, a subset of machine learning, etc.) involves inferring patterns from inputs to select parameters for the ML/AI model (e.g., without the benefit of expected (e.g., labeled) outputs). Generally speaking, unsupervised learning is particularly useful when attempting to identify relationships in unlabeled data.

In examples disclosed herein, ML/AI models are trained using reinforcement learning. However, any other training algorithm/technique may additionally or alternatively be used. In examples disclosed herein, training is performed until convergence, which is aided through the use of neural networks. Training is performed using hyperparameters that control how the learning is performed (e.g., a learning rate, a number of layers to be used in the machine learning model, etc.). In examples disclosed herein, hyperparameters that control the discount factor enable varying degrees of learning experimentation and attempts to “try.” Such hyperparameters are selected by, for example, empirical observation, time constraints, etc. In some examples re-training may be performed.

For some ML approaches, training is performed using training data. In examples disclosed herein, the training data originates from a code corpus of code samples deemed to be particularly useful and error free (e.g., industry standard code). Because supervised training may be used, the training data is labeled. However, labelled data may also be useful in reinforcement learning to provide additional states and/or corresponding actions of particular code functions.

In some examples, once training is complete, the model is deployed for use as an executable construct that processes an input and provides an output based on the network of nodes and connections defined in the model. The model is stored at local storage devices (e.g., databases) and/or network-accessible storage devices (e.g., cloud-based storage services).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

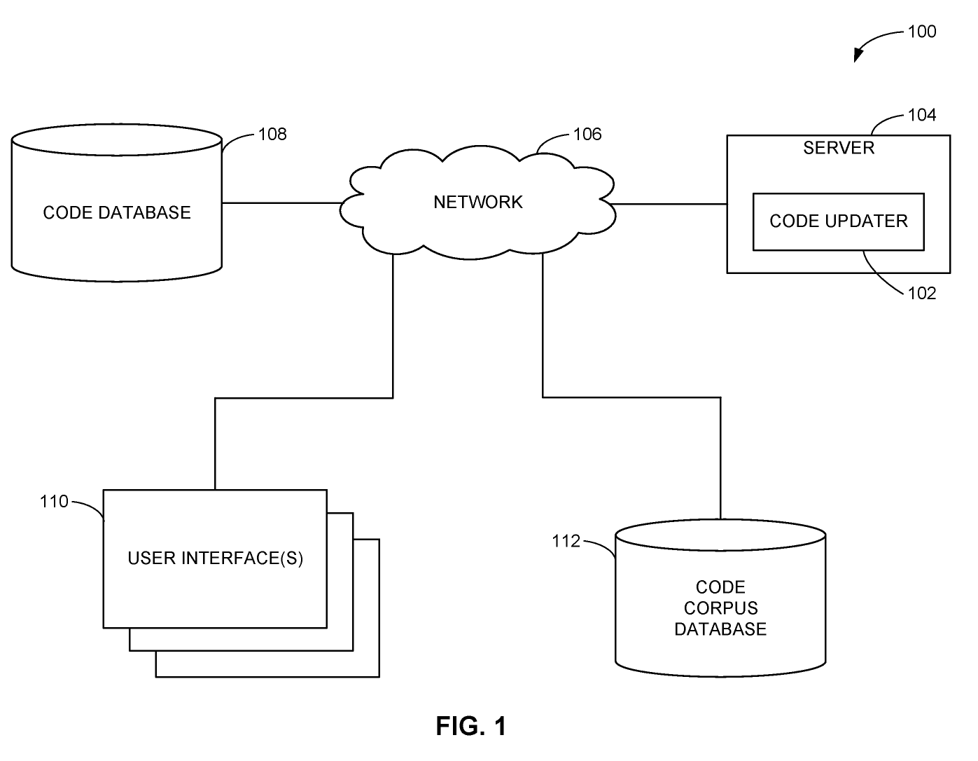

FIG. 1 is a schematic illustration of an example code updating system 100 constructed in a manner consistent with this disclosure to improve code characteristics of candidate code. In the illustrated example of FIG. 1, the code updating system 100 includes an example code updater 102 to improve code characteristics of candidate code (e.g., code samples, code segments, algorithms, pseudo-code, etc.) developed by code developers at one or more example user interfaces 110. The example user interfaces 110 are communicatively connected to the example code updater 102 via an example network 106. In some examples, the candidate code is transmitted, retrieved and/or otherwise received by the example code updater 102 from an example code database 108 rather than from one or more code developers at the one or more example user interfaces 110. For instance, one or more samples of candidate code (previously) written by a particular code developer are stored in the example code database 108, stored in a memory of one of the example user interfaces 110, and/or stored in a memory of an example server 104, all of which are communicatively connected via the example network 106. The illustrated example of FIG. 1 also includes an example code corpus database 112. In some examples, the code corpus database 112 stores different code samples of industry standard and/or otherwise vetted code.

In operation, and as described in further detail below, the example code updater 102 retrieves, receives and/or otherwise obtains candidate code (e.g., original code), such as candidate code written by a code developer. The example code updater 102 evaluates the code in connection with two or more objective functions. In some examples, the code updater 102 evaluates patterns and/or behaviors associated with the code developer to assign weight values to respective ones of the two or more objective functions. Such adaptive weight determination techniques are further evaluated by the code drafters in one or more feedback loops to confirm that they agree with different changes and/or alternate code selection activities. In some examples, the code developer provides particular weight values (e.g., in lieu of behavioral analysis of code developer preferences) to the code updater 102 in a manner consistent with code development preferences. In still other examples, the code updater 102 assigns particular weight values to respective ones of the objective functions based on a type of task. For instance, in the event of a programming task associated with consumer data, financial data, health data, etc., the example code updater 102 assigns a relative weight value to a security-related objective function that is greater than other objective functions, such as code performance. The example code updater 102 examines the candidate code to identify one or more functions therein and develops different state and action pairs, some of which are derived from available code stored in the example code corpus database 112. The example code updater 102 determines particular weighted reward values and further maps particular state and action pairs to those rewards in an effort to identify optimized code to replace and/or otherwise augment the original candidate code.

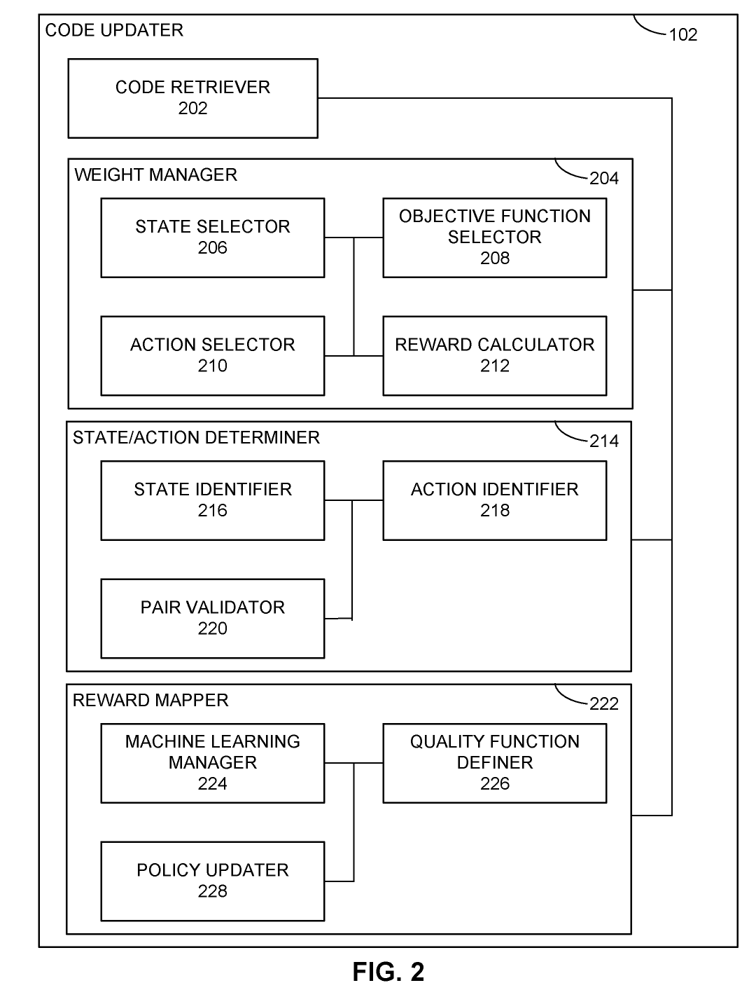

FIG. 2 is a schematic illustration of the example code updater 102 of FIG. 1. In the illustrated example of FIG. 2, the code updater 102 includes an example code retriever 202 and an example weight manager 204. The example weight manager 204 includes an example state selector 206, an example objective function selector 208, an example action selector 210, and an example reward calculator 212. The example code updater 102 of FIG. 2 also includes an example state/action determiner 214, which includes an example state identifier 216, an example action identifier 218 and an example pair validator 220. The example code updater 102 of FIG. 2 also includes an example reward mapper 222, which includes an example machine learning manager 224, an example quality function definer 226 and an example policy updater 228.

In operation, the example code retriever 202 retrieves, receives and/or otherwise obtains candidate code (sometimes referred to herein as “original code”) to be evaluated by the example code updater 102 to improve one or more code characteristics of that candidate code. As described above, in some examples the code retriever 202 retrieves code from a code developer (user) that is interacting with a particular integrated development environment (IDE). Code entered in such IDEs may be stored on a local device (e.g., a memory of a respective example user interface 110), stored in the example code database 108 and/or stored within a memory of the example server 104. The example code updater 102 identifies an associated user that is invoking and/or otherwise accessing the example code updater 102 to begin analysis of candidate code. As described above, knowledge of the particular user that is invoking the services of the code updater 102 allows code modification to occur in a manner that is consistent with user expectations and/or preferences. However, in some examples the preferences of the user may be set aside in view of a particular code development task that is being analyzed. For instance, despite a particular user having a strong desire to maintain code originality, coding tasks corresponding to security may take priority to emphasize and/or otherwise modify the candidate code in a manner that bolsters, strengthens and/or otherwise improves the candidate code in terms of security concerns.

In the event the example code retriever 202 does not identify a known user or identifies a first-time user, the example weight manager 204 sets default weight values for respective objective functions. In some examples, the weight manager 204 prompts the user for preferred weight values for the respective objective functions. Stated differently, because there are many different objectives for code generation (e.g., execution time improvements, bug reduction improvements, style adherence, security considerations, etc.), the code developer may enter or otherwise provide a particular weight vector. For instance, if the code developer considers application execution time as a key improvement objective, and considers unique coding style as another objective to maintain, then the example weight manager 204 may apply a weight vector in a manner consistent with example Equation 1.

w=[0.6, 0.4, 0,0] Equation 1.

In the illustrated example of Equation 1, w represents a weight vector, and four separate scalar weight value placeholders are shown. Each of the scalar weight values are separated by a comma, and the first placeholder corresponds to a first objective function having a value of 0.6, the second placeholder corresponds to a second objective function having a value of 0.4, and the last two placeholders correspond to third and fourth objective functions having a value of zero. For the sake of discussion, if the first scalar weight value placeholder corresponds to unique coding style, then the value of 0.6 represents a relative highest weight for all considered objective functions, while the value of 0.4 represents a second-most important objective function. While the illustrated example of Equation 1 includes four scalar weight value placeholders, examples disclosed herein are not limited thereto. Any number of different objective functions may be represented with corresponding weight value(s).

In the event the code retriever 202 identifies a particular user, then the weight manager 204 retrieves previously stored (e.g., previously determined, previously observed behaviors or preferences associated with the respective objective functions, etc.) objective function weight values to be applied in the analysis of the candidate code. Over time, the example code updater 102 utilizes observed behaviors of the code developer to produce and/or otherwise update the candidate code with optimizations consistent with particular objective function influences, which includes feedback from the code developer.

Prior to establishing a reinforcement learning agent to determine how the candidate code is to be modified and/or otherwise optimized in connection with reward calculation(s) (e.g., cost functions), the example state/action determiner 214 employs one or more heuristic techniques to extract state and action information from the candidate code. As used herein, a state represents an immediate circumstance of an agent. For instance the state of the agent reading this sentence is ‘sitting at a desk.’ As used herein, an action represents one of the possible activities that, when performed, cause a change in state. For instance, the action of ‘eating’ results in a state of ‘full’ for the agent. The example heuristic techniques (e.g., clustering, topic model-based clustering, bag-of-words modeling, etc.) identify actions that correspond to a given state. As a simple example, if a current state is ‘hungry’, then an action of ‘eating’ establishes an alternate state of ‘full.’

Analogously, the candidate code to be optimized includes functions (e.g., function calls), which are deemed to be different states. Depending on one or more parameters of the function call, which are analogous to actions, the code can reside in an alternate state (e.g., a function call jump to a different section of code that resides in an alternate state). The actions that may occur when in a particular state (e.g., a function from the candidate code) include assignments, invoking other functions (e.g., functions to jump-to), establishing relationships between functions, etc. Additionally, in some examples the state identifier 216 evaluates syntax characteristics detection techniques to verify respective states (functions) of (within) the candidate code, and the example action identifier 218 uses bag-of-words modeling to identify, for example, candidate variable assignments of a particular function (e.g., variable values, variable types, etc.), nested function calls (e.g., related functions), jump instructions, and/or offloading instructions (e.g., instructions to invoke graphics processing units (GPUs), instructions to invoke field programmable gate arrays (FPGAs), etc.).

Through heuristic modeling, any number of states and actions may be identified, but not all actions are properly associated with particular states. For instance, heuristic modeling may identify the states of ‘hungry,’ ‘full’, ‘lost,’ and ‘at destination.’ While the action of ‘eat’ is an appropriate associated action for a state of ‘hungry,’ it would not be an appropriate selection for the state of ‘lost.’ Alternatively, an action of ‘use GPS’ would be an appropriate action corresponding to a state of ‘lost’ to ultimately reach a (desired) state of ‘at destination’. As such, the example action identifier 218 identifies candidate actions associated with a selected state of interest, and the example pair validator 220 identifies one or more valid pairs of states and corresponding actions that can be tested for corresponding rewards (e.g., reward values calculated by a reward function), as described in further detail below.

In some examples, the heuristic modeling identifies particular functions of the candidate code, and the example state identifier 216 searches the example code corpus database 112 for similar functions that can be considered during the evaluation of the candidate code. For instance, because examples disclosed herein seek particular actions associated with particular states that maximize a reward function (e.g., a reward function weighted in connection with preferences), the analysis of similar candidate functions in the example code corpus database 112 provides further exploratory opportunities regarding how the provided candidate code can be modified. Generally speaking, the quantity of (a) states and (b) corresponding actions for each state is too numerous for human tracking, as the possible permutations exhibit a complex and time-consuming endeavor when attempting to detect patterns in a large set of input data. Accordingly, examples disclosed herein facilitate such analysis in view of any number of objective functions of interest that are considered together when optimizing candidate code.

The example weight manager 204 determines weighted reward function values in view of the collected state and action combination (pair) information. As disclosed below, the reward function values are determined in a recursive manner by iterating through any number of different states of interest, corresponding objective functions with which to optimize in connection with associated weighting values, and any number of different actions that exhibit varying degrees of reward magnitudes in view of a selected objective function. In particular, the example state selector 206 selects one state of interest (e.g., a function from the candidate code), which is sometimes labeled with the variable “s”. The example objective function selector 208 selects one of the objective functions of interest to evaluate and generates a sub-agent corresponding to the selected objective function. As used herein, a sub-agent is a representation (e.g., a mathematical representation) of influence for a particular objective function and a selected state. Each sub-agent has a corresponding objective function that it attempts to maximize. Depending on a corresponding action for the selected state, different reward values (magnitude values) may result, some of which have a stronger (e.g., greater, higher reward value, etc.) benefit for promoting the objective function of interest. Taken in the aggregate, sub-agents produce a corresponding total optimization effect or total reward value for modified code.

The example action selector 210 selects one of the candidate actions (“a”) that are valid for the selected state. Stated differently, examples disclosed herein model code permutations of states and actions as a sequence of actions that maximize a reward function, which may be formulated in connection with any number of objectives of interest (e.g., reduce run-time of the code, reduce code size, execute faster, reduce code errors, reduce code vulnerabilities, etc.). Examples disclosed herein employ deep reinforcement learning to model such interactions between code segments (e.g., particular states and actions and particular sequences of such states and actions). For instance, if the objective for the candidate code is to maximally reduce run time, then examples disclosed herein model a reduction in run time as the reward function during reinforcement learning techniques. As the reward function value increases, then this represents a relatively closer achievement of reducing the run time for a particular sequence of states and actions. In other words, the particular sequence of states and actions that results in the highest reward function value represents a corresponding execution path that the candidate code should employ.

The example reward calculator 212 calculates a reward in connection with the selected objective function of interest. In some examples, the reward calculator 212 determines the reward in a manner consistent with example Equation 2.

Rₜ=rₜ+γRₜ₊₁ Equation 2.

In the illustrated example of Equation 2, Rₜ represents a total reward at time t, and rₜ represents a reward (e.g., a reduction in time of code execution) of choosing an action a at time t (aₜ). The variable gamma (γ) represents a discount factor to control a relative importance of rewards in a longer-term as compared to immediate rewards. In the event the discount factor (γ) is set to 1, then the same actions will result in the same rewards (e.g., no exploration will occur). Each sub-agent may evaluate any number of different candidate actions for a given state for a given objective function of interest. Resulting reward values may be stored and/or otherwise aggregated so that the example reward calculator 212 can create an overall reward function for the plurality of objective functions to be maximized for the candidate code. Additionally, because each reward function includes a corresponding weight value, the overall reward function considers the two or more reward function influences in an aggregate manner to generate optimized code that reflects the influence of all objective functions of interest. In other words, a single objective function is not analyzed in a vacuum or separately from one or more additional objective functions when determining an aggregate reward that is maximized in view of all objective functions of interest.

However, in view of the large quantity of possible states, with each state having a large quantity of candidate actions, and each state/action combination having a possible sequence that can result in a different reward value, the example machine learning manager 224 is invoked by the example reward mapper 222. As described in further detail below, the example reward mapper 222 facilitates determination of an optimized policy (π) to map state/action pairs that, when implemented, reveal particular code optimizations that satisfy the objective functions. Generally speaking, a policy is a strategy or set of state/action pairs that an agent (sub-agent) employs to get to a subsequent state (based on a current state). Preferably, the policy results in a greatest reward. In some examples, the policy is represented in a manner consistent with example Equation 3.

π(aₜ/sₜ) Equation 3.

In the illustrated example of Equation 3, aₜ represents an action at time t, and sₜ represents a state at time t. The example quality function definer 226 defines an action quality function (Q) in an effort to map probable rewards of the previously determined state/action pairs. In particular, a Q-function takes as its input an agent's state and action (e.g., the state/action pairs and corresponding rewards determined above), and maps such pairs to rewards in a probabilistic manner. The Q-function (or Q-factor) refers to a long-term return of a current state in view of a candidate policy (π), in which the Q-function maps state/action pairs to rewards. In particular, the example quality function definer defines the Q-function in a manner consistent with example Equation 4.

Q*(s, a)=max_{π}Q^{π}(s, a) Equation 4.

In the illustrated example of Equation 4, a starting policy (π) is established that, in connection with a neural network convergence, reveals optimized state/action pairs to identify the optimized code. The quantity Q^{π}(s, a) represents a reward of a state/action pair (s, a) based on the policy π. Q*(s, a) represents a maximum achievable reward for a given state/action pair (s, a). The example policy updater 228 updates a policy (π) iteration in a manner consistent with example Equation 5.

π*=argmaxₐQ*(s, a) Equation 5.

In the illustrated example of Equation 5, the policy updater 228 determines a next (e.g., iterative) optimal action, which will yield the maximum reward for a given state s. The example quality function definer 226 determines an optimal value function for this particular iteration in a manner consistent with example Equations 6 and 7.

Q*(s, a)=rₜ₊₁+γ*maxₐ_{ₜ₊₁}Q*(sₜ₊₁, aₜ₊₁) Equation 6.

In the illustrated example of Equation 6, the policy updater 228 determines the optimal value by maximizing over all (currently attempted) decisions. Additionally, the example policy updater 228 employs a Bellman technique in a manner consistent with example Equation 7.

Q*(s, a)=E[r+γ*max_{a′}Q*(s′, a′|s, a] Equation 7.

In the illustrated example of Equation 7, the maximum Q-value resulting from a state/action pair (s, a) is estimated by the statistical expectation (E) of the immediate reward r (at state s and action a) and a discounted maximum Q-value that is possible from the next resulting state thereafter (s′), where γ represents the discount value/rate. Thus, during this iteration, the highest Q-value results from also choosing and/or otherwise selecting that subsequent state s′. The importance of such subsequent actions is guided by a corresponding gamma (γ) value selection to, for example, promote alternate state/action selection permutations. In other words, the example Bellman technique (e.g., as represented in example Equation 7) facilitates rewards from future states (e.g., s′) to propagate to other states in a recursive manner. For instance, and as described above, aggregation occurs in connection with individual reward functions. In some examples, a first sub-agent (e.g., sub-agent 1) corresponding to a first objective function of interest has state/action pairs (s₁₁, a₁₁), (s₂₁, a₂₁), . . . (sₙ₁, aₙ₁). The example reward mapper 222 generates, calculates and/or otherwise estimates a corresponding first reward function (R₁) of the first sub-agent. The example quality function definer 226 learns a corresponding Q-function by approximating the reward R₁. However, because examples disclosed herein are not limited to a single objective function of interest, but instead consider the interplay between any number of objective functions and their overall effect, a second (or more) sub-agent (e.g., sub-agent 2) is considered that corresponds to a second objective function of interest that has state/action pairs (s₁₂, a₁₂), (s₂₂, a₂₂), . . . (sₙ₂, aₙ₂). Similarly, the example reward mapper 222 estimates a corresponding second reward function (R₂) of the second sub-agent. The example reward calculator 212 then determines the overall reward function as R=w1*R1+w2*R2+. . . , which is then optimized.

Additionally, because example the Bellman technique is recursive, initial values are not necessarily known, but will converge during recursive application. Accordingly, the example reward mapper 222 invokes the example machine learning manager 224 to implement the neural network to aid in convergence. In response to the example reward mapper 222 identifying a degree of convergence (e.g., a threshold convergence differential value), the example policy updater 228 releases the optimized policy, which includes state/action pairs and/or sequences thereof that modify the candidate code to optimized code (e.g., assigning particular action selections for respective states (functions) in the candidate code). In other words, the resulting policy is determined as the one or more paths or state/action pairs that yield the highest overall reward.

In some examples, the code updater 102 invokes one or more static security analyzers to facilitate sandboxing techniques. The example sandboxing techniques invoked by the code updater 102 verify whether machine generated programs (e.g., code optimized by the example aforementioned techniques) contain any (e.g., known) vulnerabilities. Generally speaking, joint optimization of two or more objective functions does not necessarily mean that the resulting code optimization is appropriate for every use-case, then one or more objective functions may be “stressed.” For instance, if security is an important objective function of interest, then the example code updater 102 executes the optimized code in a sandboxed environment and measures dynamic runtime metrics (e.g., memory performance overhead, fuzz tests, and/or other program behaviors). In the event of code crash instances and/or metrics that fail one or more thresholds, the example code updater 102 may reject the optimized code and re-optimize with one or more alternate weight values assigned to respective objective functions.

While an example manner of implementing the code updater 102 of FIGS. 1 and 2 is illustrated in FIG. 2, one or more of the elements, processes and/or devices illustrated in FIGS. 1 and 2 may be combined, divided, re-arranged, omitted, eliminated and/or implemented in any other way. Further, the example code retriever 202, the example weight manager 204, the example state selector 206, the example objective function selector 208, the example action selector 210, the example reward calculator 212, the example state/action determiner 214, the example state identifier 216, the example action identifier 218, the example pair validator 220, the example reward mapper 222, the example machine learning manager 224, the example quality function definer 226, the example policy updater 228 and/or, more generally, the example code updater 102 of FIGS. 1 and 2 may be implemented by hardware, software, firmware and/or any combination of hardware, software and/or firmware. Thus, for example, any of the example code retriever 202, the example weight manager 204, the example state selector 206, the example objective function selector 208, the example action selector 210, the example reward calculator 212, the example state/action determiner 214, the example state identifier 216, the example action identifier 218, the example pair validator 220, the example reward mapper 222, the example machine learning manager 224, the example quality function definer 226, the example policy updater 228 and/or, more generally, the example code updater 102 of FIGS. 1 and 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example code retriever 202, the example weight manager 204, the example state selector 206, the example objective function selector 208, the example action selector 210, the example reward calculator 212, the example state/action determiner 214, the example state identifier 216, the example action identifier 218, the example pair validator 220, the example reward mapper 222, the example machine learning manager 224, the example quality function definer 226, the example policy updater 228 and/or, more generally, the example code updater 102 of FIGS. 1 and 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example code updater 102 of FIGS. 1 and 2 may include one or more elements, processes and/or devices in addition to, or instead of, those illustrated in FIGS. 1 and/or 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

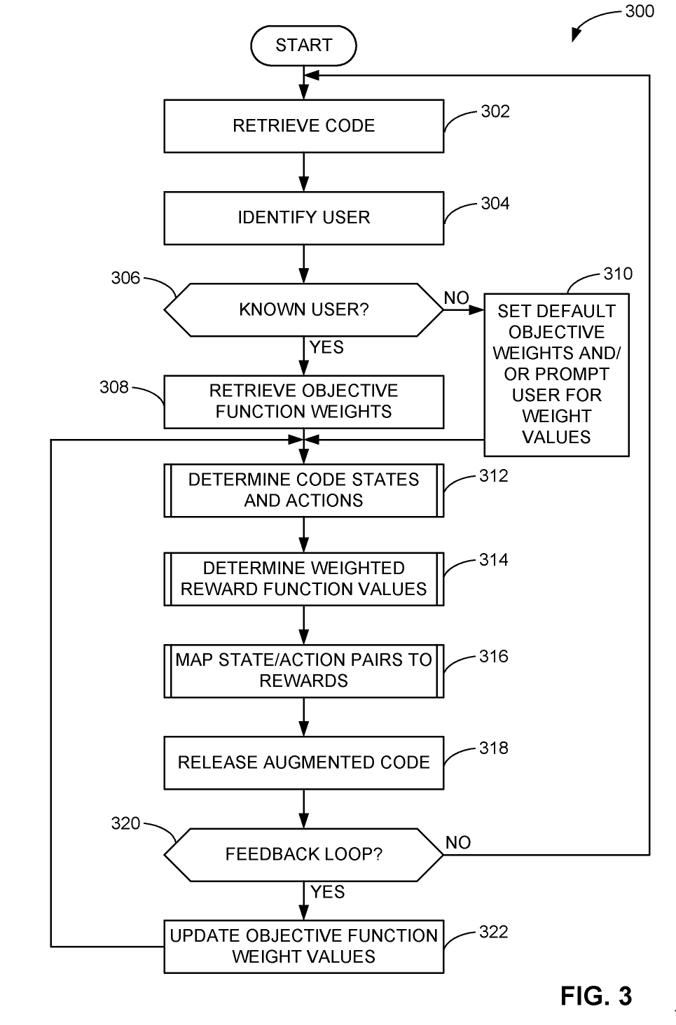

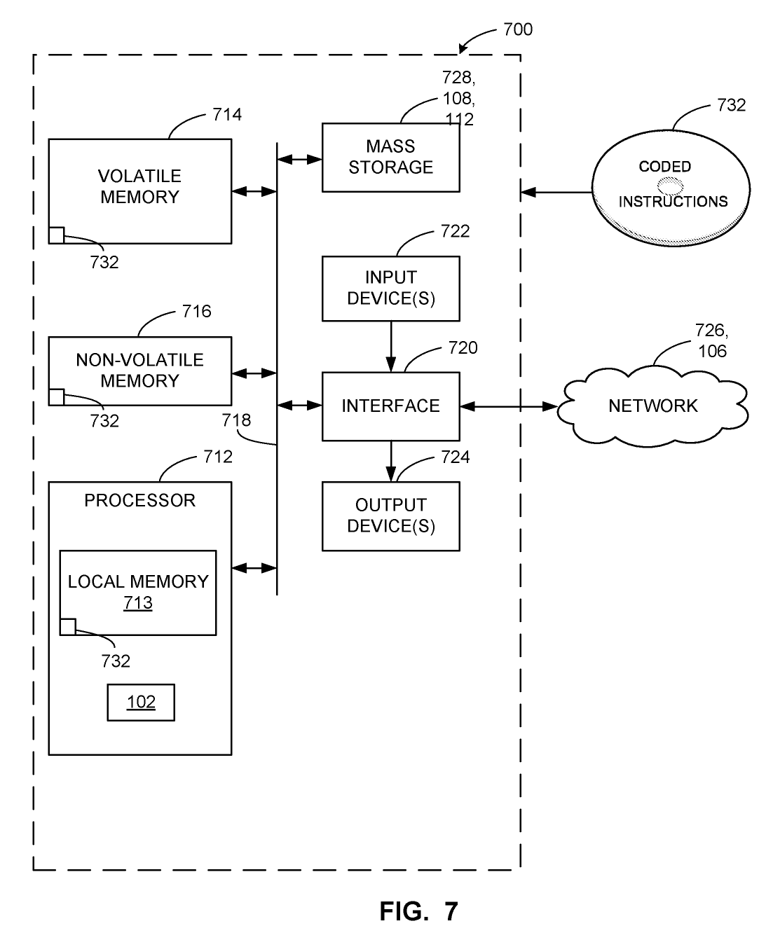

Flowcharts representative of example hardware logic, machine readable instructions, hardware implemented state machines, and/or any combination thereof for implementing the code updater 102 of FIGS. 1 and 2 are shown in FIGS. 3-6. The machine readable instructions may be one or more executable programs or portion(s) of an executable program for execution by a computer processor such as the processor 712 shown in the example processor platform 700 discussed below in connection with FIG. 7. The program(s) may be embodied in software stored on a non-transitory computer readable storage medium such as a CD-ROM, a floppy disk, a hard drive, a DVD, a Blu-ray disk, or a memory associated with the processor 712, but the entire program(s) and/or parts thereof could alternatively be executed by a device other than the processor 712 and/or embodied in firmware or dedicated hardware. Further, although the example program is described with reference to the flowcharts illustrated in FIGS. 3-6, many other methods of implementing the example code updater 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3-6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program 300 of FIG. 3 includes block 302 in which the example code retriever 202 retrieves candidate code and identifies a corresponding user associated with the candidate code (block 304). If the example code retriever 202 does not identify a corresponding user associated with the candidate code (block 306), then the example weight manager 204 sets default values for one or more objective functions, or prompts the user for weight values (block 310). In some examples, the weight manager 204 assigns corresponding weights to the objective functions based on a task type, such as a code task/objective related to sensitive privacy considerations. In the event the example code retriever 202 identifies a corresponding user associated with the candidate code (block 306), then the example weight manager 204 retrieves objective weight values for the corresponding objective weights of interest (block 308), such as weights stored in the example code database 108, a local storage of the user interface 110, or a storage associated with the example server 104.

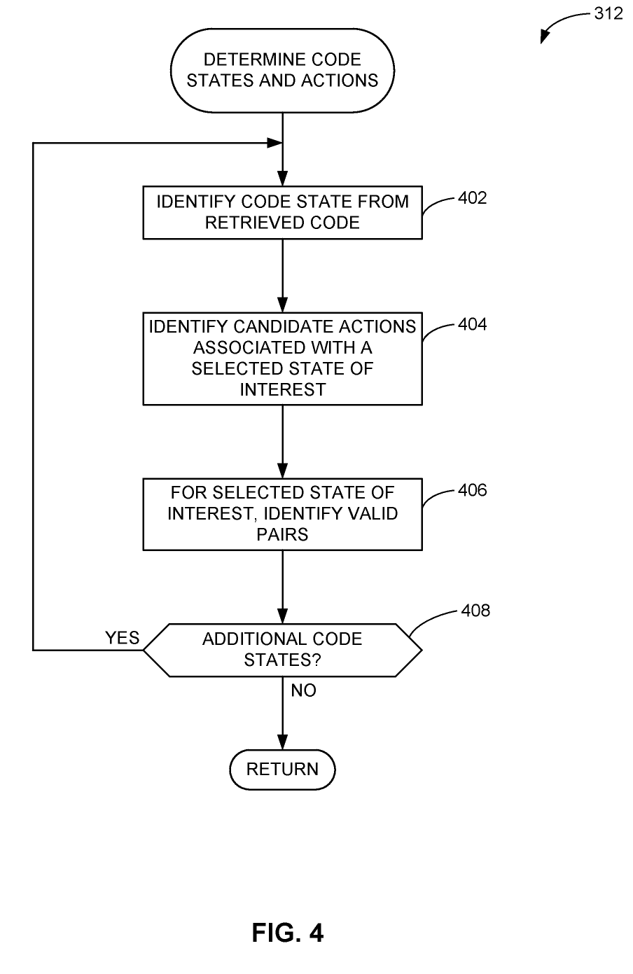

The example state/action determiner 214 determines (identifies) one or more code states associated with the candidate code, as well as identifying corresponding actions associated with each identified state (block 312), as described above and in further detail below in connection with FIG. 4. The example weight manager 204 determines weighted reward function values associated with combinations of (a) states, (b) corresponding actions and (c) different combinations of objective functions and their associated weights (block 314). Based on aggregated reward scores of such combinations, the example reward mapper 222 maps state and action pairs to the rewards in a probabilistic manner such that those state/action pairs can be used to select which code modifications to make to the candidate code (block 316). The example code updater 102 releases the updated code to the code developer (block 318) such that it can be implemented in a corresponding code development project. The example code retriever 202 determines whether a feedback loop is desired (block 320) and, if not, control returns to block 302 to retrieve new/alternate candidate code to be analyzed for optimization in connection with two or more objective functions. On the other hand, in the event feedback is to occur (block 320), then the example weight manager 204 updates one or more weight values associated with the objective functions in view of the retrieved and/or otherwise received feedback information (block 322). For instance, the code developer might determine that the weight values associated with security are too high and adversely affecting code performance. As such, one or more weight values may be adjusted to consider relative emphasis on particular objective functions.

FIG. 4 illustrates additional detail associated with determining the code states and actions of the candidate code of block 312. In the illustrated example of FIG. 4, the example state identifier 216 one of the code states from the candidate code (block 402). As described above, a code state refers to a function within the candidate code, such as a function call. The example action identifier 218 identifies one or more candidate actions associated with the selected state (block 404). As described above, each code state may have any number of associated actions that, when selected and/or otherwise utilized (e.g., a particular jump instruction called by the function), cause a change from a current state to a next state.

However, while a particular action might be a valid input for a state (e.g., a particular parameter called by the function), not all state and action pairs are appropriate selections for a current state. For instance, consider the event that the current state (e.g., current function of the candidate code) is associated with a CPU offloading request, in which actions may include a request to offload to a GPU, a request to offload to an FPGA, or a request to offload to a different processor core. Also consider that the current platform of interest only has access to GPU resources, but no access to FPGA resources or alternate processor cores. As such, the only valid state/action pair corresponds to the action of offload to GPU. The example pair validator 220 identifies such valid state and action pair combinations (block 406). In some examples, the pair validator 220 searches the example code corpus database 112 for similar states. Because the code corpus database 112 contains any number of previously identified and/or otherwise “vetted” functions, it is a source of opportunity to try alternate actions for a given state. For instance, while the code developer may not have considered additional candidate actions for a given state, the example pair validator 220 may identify one or more alternate candidate actions to try, such as an action to offload to a virtual machine (VM). Such additional opportunities are later considered when determining corresponding reward values of particular state/action combinations and further sequences thereof. The example state identifier 216 determines whether there are additional states of interest to evaluate (block 408) and, if so, control returns to block 402.

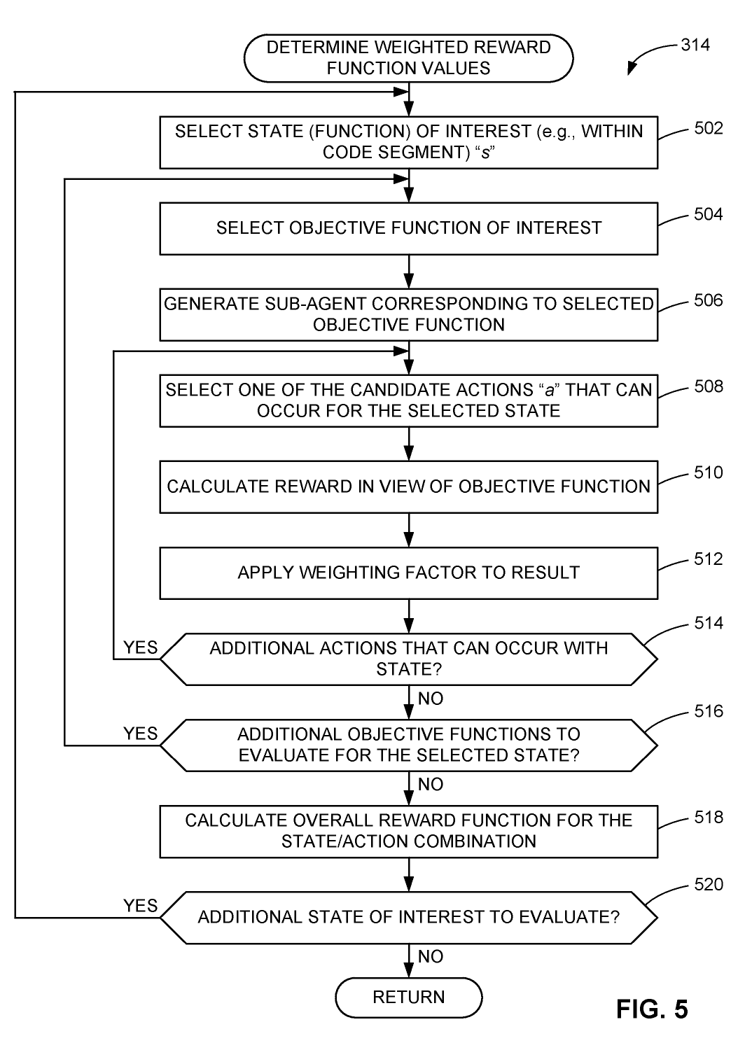

FIG. 5 illustrates additional detail corresponding to determining weighted reward function values of block 314 of FIG. 3. In the illustrated example of FIG. 5, the example state selector 206 selects one of the previously identified states (block 502), and the example objective function selector 208 selects one of the objective functions of interest (block 504). As each objective function has a corresponding weight, in which each objective function will exhibit a particular weighted influence on an overall reward function, the example objective function selector 208 generates a sub-agent corresponding to the selected objective function (block 506). In particular, the example program 314 of FIG. 5 will perform iterations for any number of states of interest “s,” corresponding objective functions of interest, and corresponding actions associated with the respective states of interest. While a reward function value will result for each weighted objective function, upon completion of any number of iterations an overall (aggregate) reward function is determined for state/action combinations to consider for an optimized policy.

The example action selector 210 selects one of the candidate actions “a” that can occur for the selected state “s” (block 508), and the example reward calculator 212 calculates a reward in view of the selected objective function (block 510). The example weight manager 204 applies the weighting factor to the calculated reward (block 512), and the example action selector 210 determines whether there are additional actions “a” to evaluate in view of the selected state “s” (block 514). If so, then control returns to block 508 to perform at least one additional iteration. If not, then the example objective function selector 208 determines whether there are additional objective functions to be evaluated in connection with the candidate states and actions (block 516). If so, then control returns to block 508 to perform at least one additional iteration. However, in the event that all objective functions of interest have been considered in view of the candidate state/action pairs to calculate reward metrics (block 516), then the example reward calculator 212 calculates an overall reward function for the state/action combinations (block 518). Considering that the candidate code may have any number of states to be evaluated, the example state selector 206 determines whether one or more have not yet been evaluated (block 520). If there are additional states to evaluate, then control returns to block 502.

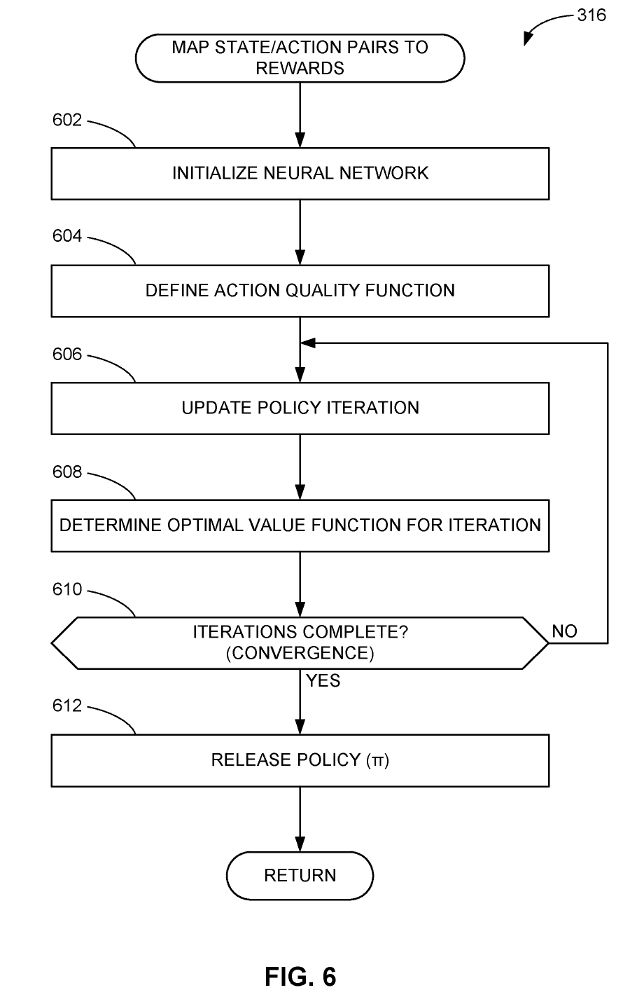

FIG. 6 illustrates additional detail corresponding to mapping state/action pairs to rewards of block 316 of FIG. 3. In the illustrated example of FIG. 6, the example machine learning manager 224 initializes a neural network (block 602), which is helpful when determining convergence for particular models and/or functions. The example quality function definer 226 defines an action quality function (block 604), such as that illustrated in the example of Equation 4. The example policy updater 228 updates a policy (n) (block 606), which may initially contain random values during a first iteration, but will converge with the aid of the example neural network. The example quality function definer 226 determines an optimal value function for a current iteration (block 608), such as by way of the Bellman technique illustrated in example Equations 6 and 7. The example reward mapper 222 determines whether convergence has occurred (block 610) and, if not, control returns to block 606 to advance convergence attempts with the neural network. Otherwise, the example policy updater 228 releases the converged policy (n) to allow the example code updater 102 to update the candidate code with specific state/action pairs and sequences thereof that, in the aggregate, maximize the objective functions in a manner consistent with the desired weights (block 612).

FIG. 7 is a block diagram of an example processor platform 700 structured to execute the instructions of FIGS. 3-6 to implement the code updater 102 of FIGS. 1 and 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example code updater 102 and the structure therein.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 3-6 may be stored in the mass storage device 728, in the volatile memory 714, in the non-volatile memory 716, and/or on a removable non-transitory computer readable storage medium such as a CD or DVD.

From the foregoing, it will be appreciated that example methods, apparatus and articles of manufacture have been disclosed that consider two or more characteristics (e.g., objective functions) of interest when determining optimization changes to be made to candidate code provided by a code developer. Rather than reliance upon code developer discretion or code developer attempts to identify particular combinations of states and actions that maximize one particular objective function, examples disclosed herein identify valid candidate combinations of states and actions and determine respective reward scores based on a plurality weighted objective function values. Additionally, examples disclosed herein format aggregate reward values having particular state/action combinations for application to a neural network to facilitate convergence of a quality function. As such, particular state/action pairs and sequences of such state/action pairs are identified by examples disclosed herein to optimize the candidate code provided by, for instance, a code developer. Such optimized code improves respective objective functions (characteristics) of the candidate code in an aggregate manner with other objective functions, unlike traditional optimization techniques that treat particular characteristic modifications in a vacuum from one or more alternate characteristic modifications.

Example methods, apparatus, systems, and articles of manufacture to improve code characteristics are disclosed herein. Further examples and combinations thereof include the following:

Example 1 includes an apparatus to modify candidate code, the apparatus comprising a weight manager to apply a first weight value to a first objective function, a state identifier to identify a first state corresponding to the candidate code, an action identifier to identify candidate actions corresponding to the identified first state, a reward calculator to determine reward values corresponding to respective ones of (a) the identified first state, (b) one of the candidate actions and (c) the first weight value, and a quality function definer to determine a relative highest state and action pair reward value based on respective ones of the reward values.

Example 2 includes the apparatus as defined in example 1, further including a machine learning engine to estimate a quality function by applying the respective ones of the reward values to a neural network.

Example 3 includes the apparatus as defined in example 2, wherein the quality function definer is to define the quality function as a Bellman estimation.

Example 4 includes the apparatus as defined in example 1, further including an objective function selector to select a second objective function, and invoke the weight manager to apply a second weight value to the second objective function.

Example 5 includes the apparatus as defined in example 4, wherein the reward calculator is to calculate an aggregate reward for the reward values based on the first and second objective functions.

Example 6 includes the apparatus as defined in example 1, wherein the state identifier is to iteratively identify additional states corresponding to the candidate code, the action identifier to identify additional candidate actions corresponding to the respective additional states.

Example 7 includes the apparatus as defined in example 1, wherein the weight manager is to determine the first weight value for the first objective function and a second weight value for a second objective function based on behavioral observation of a code developer associated with the candidate code.

Example 8 includes a non-transitory computer readable storage medium comprising computer readable instructions that, when executed, cause at least one processor to at least apply a first weight value to a first objective function, identify a first state corresponding to candidate code, identify candidate actions corresponding to the identified first state, determine reward values corresponding to respective ones of (a) the identified first state, (b) one of the candidate actions and (c) the first weight value, and determine a relative highest state and action pair reward value based on respective ones of the reward values.

Example 9 includes the non-transitory computer readable storage medium as defined in example 8, wherein the instructions, when executed, cause the at least one processor to estimate a quality function by applying the respective ones of the reward values to a neural network.

Example 10 includes the non-transitory computer readable storage medium as defined in example 9, wherein the instructions, when executed, cause the at least one processor to define the quality function as a Bellman estimation.

Example 11 includes the non-transitory computer readable storage medium as defined in example 8, wherein the instructions, when executed, cause the at least one processor to select a second objective function, and invoke the weight manager to apply a second weight value to the second objective function.

Example 12 includes the non-transitory computer readable storage medium as defined in example 11, wherein the instructions, when executed, cause the at least one processor to calculate an aggregate reward for the reward values based on the first and second objective functions.

Example 13 includes the non-transitory computer readable storage medium as defined in example 8, wherein the instructions, when executed, cause the at least one processor to iteratively identify additional states corresponding to the candidate code, the action identifier to identify additional candidate actions corresponding to the respective additional states.

Example 14 includes the non-transitory computer readable storage medium as defined in example 8, wherein the instructions, when executed, cause the at least one processor to determine the first weight value for the first objective function and a second weight value for a second objective function based on behavioral observation of a code developer associated with the candidate code.

Example 15 includes a computer-implemented method to modify candidate code, the method comprising applying, by executing an instruction with at least one processor, a first weight value to a first objective function, identifying, by executing an instruction with the at least one processor, a first state corresponding to candidate code, identifying, by executing an instruction with the at least one processor, candidate actions corresponding to the identified first state, determining, by executing an instruction with the at least one processor, reward values corresponding to respective ones of (a) the identified first state, (b) one of the candidate actions and (c) the first weight value, and determining, by executing an instruction with the at least one processor, a relative highest state and action pair reward value based on respective ones of the reward values.

Example 16 includes the method as defined in example 15, further including estimating a quality function by applying the respective ones of the reward values to a neural network.

Example 17 includes the method as defined in example 16, further including defining the quality function as a Bellman estimation.

Example 18 includes the method as defined in example 15, further including selecting a second objective function, and invoking the weight manager to apply a second weight value to the second objective function.

Example 19 includes the method as defined in example 18, further including calculating an aggregate reward for the reward values based on the first and second objective functions.

Example 20 includes the method as defined in example 15, further including iteratively identifying additional states corresponding to the candidate code, the action identifier to identify additional candidate actions corresponding to the respective additional states.

Example 21 includes the method as defined in example 15, further including determining the first weight value for the first objective function and a second weight value for a second objective function based on behavioral observation of a code developer associated with the candidate code.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to modify candidate code, the apparatus comprising:
a weight manager to apply a first weight value to a first objective function;
a state identifier to identify a first state corresponding to the candidate code;
an action identifier to identify candidate actions corresponding to the identified first state;
a reward calculator to determine reward values corresponding to respective ones of (a) the identified first state, (b) one of the candidate actions and (c) the first weight value; and
a quality function definer to determine a relative highest state and action pair reward value based on respective ones of the reward values.

2. The apparatus as defined in claim 1, further including a machine learning engine to estimate a quality function by applying the respective ones of the reward values to a neural network.

3. The apparatus as defined in claim 2, wherein the quality function definer is to define the quality function as a Bellman estimation.

4. The apparatus as defined in claim 1, further including an objective function selector to:
select a second objective function; and
invoke the weight manager to apply a second weight value to the second objective function.

5. The apparatus as defined in claim 4, wherein the reward calculator is to calculate an aggregate reward for the reward values based on the first and second objective functions.

6. The apparatus as defined in claim 1, wherein the state identifier is to iteratively identify additional states corresponding to the candidate code, the action identifier to identify additional candidate actions corresponding to the respective additional states.

7. The apparatus as defined in claim 1, wherein the weight manager is to determine the first weight value for the first objective function and a second weight value for a second objective function based on behavioral observation of a code developer associated with the candidate code.

8. A non-transitory computer readable storage medium comprising computer readable instructions that, when executed, cause at least one processor to at least:
apply a first weight value to a first objective function;
identify a first state corresponding to candidate code;
identify candidate actions corresponding to the identified first state;
determine reward values corresponding to respective ones of (a) the identified first state, (b) one of the candidate actions and (c) the first weight value; and
determine a relative highest state and action pair reward value based on respective ones of the reward values.

9. The non-transitory computer readable storage medium as defined in claim 8, wherein the instructions, when executed, cause the at least one processor to estimate a quality function by applying the respective ones of the reward values to a neural network.

10. The non-transitory computer readable storage medium as defined in claim 9, wherein the instructions, when executed, cause the at least one processor to define the quality function as a Bellman estimation.

11. The non-transitory computer readable storage medium as defined in claim 8, wherein the instructions, when executed, cause the at least one processor to:
select a second objective function; and
invoke the weight manager to apply a second weight value to the second objective function.

12. The non-transitory computer readable storage medium as defined in claim 11, wherein the instructions, when executed, cause the at least one processor to calculate an aggregate reward for the reward values based on the first and second objective functions.

13. The non-transitory computer readable storage medium as defined in claim 8, wherein the instructions, when executed, cause the at least one processor to iteratively identify additional states corresponding to the candidate code, the action identifier to identify additional candidate actions corresponding to the respective additional states.

14. The non-transitory computer readable storage medium as defined in claim 8, wherein the instructions, when executed, cause the at least one processor to determine the first weight value for the first objective function and a second weight value for a second objective function based on behavioral observation of a code developer associated with the candidate code.

15. A computer-implemented method to modify candidate code, the method comprising:
applying, by executing an instruction with at least one processor, a first weight value to a first objective function;
identifying, by executing an instruction with the at least one processor, a first state corresponding to candidate code;
identifying, by executing an instruction with the at least one processor, candidate actions corresponding to the identified first state;
determining, by executing an instruction with the at least one processor, reward values corresponding to respective ones of (a) the identified first state, (b) one of the candidate actions and (c) the first weight value; and
determining, by executing an instruction with the at least one processor, a relative highest state and action pair reward value based on respective ones of the reward values.

16. The method as defined in claim 15, further including estimating a quality function by applying the respective ones of the reward values to a neural network.

17. The method as defined in claim 16, further including defining the quality function as a Bellman estimation.

18. The method as defined in claim 15, further including:
selecting a second objective function; and
invoking the weight manager to apply a second weight value to the second objective function.

19. The method as defined in claim 18, further including calculating an aggregate reward for the reward values based on the first and second objective functions.

20. The method as defined in claim 15, further including iteratively identifying additional states corresponding to the candidate code, the action identifier to identify additional candidate actions corresponding to the respective additional states.

21. The method as defined in claim 15, further including determining the first weight value for the first objective function and a second weight value for a second objective function based on behavioral observation of a code developer associated with the candidate code.
